(19) United States
(12) Patent Application Publication
(10) Pub. No.: US 2013/0069421 A1
(43) Pub. Date: Mar. 21, 2013

(54) RIM LINER

(71) Applicants: Peter Gilbert, Collingwood (CA); Radu Repanovici, Mississauga (CA); Scott Wellman, Plymouth, MI (US)

(72) Inventors: Peter Gilbert, Collingwood (CA); Radu Repanovici, Mississauga (CA); Scott Wellman, Plymouth, MI (US)

(21) Appl. No.: 13/663,957

(22) Filed: Oct. 30, 2012

Related U.S. Application Data
(63) Continuation-in-part of application No. 13/619,494, filed on Sep. 14, 2012.
(60) Provisional application No. 61/535,132, filed on Sep. 15, 2011.

(51) Int. Cl. B60B 21/12

(52) U.S. Cl. 301/95.102; 301/95.101

(57) ABSTRACT

A rim assembly for receiving a tire includes a rim having an outer ring-shaped member defining an outer surface, and a rim liner having a ring-shaped body formed to generally match the contours of the outer surface of the rim. The rim liner is positioned within a recess formed in at least a portion of the outer surface of the rim so as to maintain an intended industry standard sizing for rims and tires.

### CROSS-REFERENCE TO RELATED APPLICATIONS

This application is a continuation-in-part of U.S. patent application Ser. No. 13/619,494 filed Sep. 14, 2012, which claims the benefit under 35 U.S.C. §119(e) of U.S. Provisional Patent Application No. 61/535,132 filed Sep. 15, 2011, both of which are hereby incorporated by reference in their entirety herein.

### FIELD OF THE INVENTION

The present invention relates to ensuring a seal between a tire and a rim, and in particular to a rim liner to be used with the tire and rim to reduce air leakage in the region of the bead-set and main body region of the rim.

### BACKGROUND OF THE INVENTION

Automotive wheels are typically assemblies having a tire and a rim, where the assembly is pressurized with air to a set pressure rating, typically in the region of 30 to 40 psi. As a vehicle's tires are the primary and in most cases the only contact surface with the road, they are subject to harsh conditions.

Modern automotive rims, particularly alloy rims are subject to a range of potentially degradative compounds during usage, for example road salt. Prolonged exposure to these compounds can lead to chemical attack, generally in the form of corrosion and/or oxidation of the rims. Where chemical attack occurs at the tire bead/rim interface, air leakage can occur, resulting in a loss of tire pressure. Underinflation by as little as 6 psi can have serious consequences, such as reduced tread life, reduced fuel economy and in some instances tire failure.

Road conditions also have the potential to cause physical damage to the rims. Where this damage occurs at or in proximity to the tire bead/rim interface, the chances of air leakage are increased. Once again, with underinflation of the tires, serious consequences can arise.

There is clearly a need to address the tire bead/rim interface, particularly with respect to providing additional sealing function in the event of rim chemical attack and/or physical damage.

### SUMMARY OF THE INVENTION

According to an aspect of an embodiment, provided is a rim assembly for receiving a tire. The assembly comprises a rim having an outer ring-shaped member defining an outer surface, and a rim liner having a ring-shaped body formed to generally match the contours of the outer surface of the rim. The rim liner is positioned within a recess formed in at least a portion of the outer surface of the rim so as to maintain an intended industry standard sizing for rims and tires.

According to a further aspect of an embodiment, provided is a rim liner for placement between a tire and a rim of an automotive wheel assembly. The rim liner comprises a ring-shaped body formed to generally match the contours of an outer surface of the rim, the ring-shaped body being configured to seat within a recess provided in the rim, so as to maintain an intended industry standard sizing for rims and tires.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a wheel having a tire and rim.

FIG. 2 is a perspective view of a rim shown in isolation.

FIG. 3 is a partial sectional view of the rim represented in FIG. 2.

FIG. 4 is an exploded perspective view of the rim and a rim liner configured for installation on the rim, according to an embodiment of the invention.

FIG. 5 is a partial sectional view of the rim showing a recess configured to receive the rim liner of FIG. 4.

FIGS. 6 and 7 are partial sectional views showing the rim liner of FIG. 4 in position on the rim.

FIG. 8 is a partial section view of an alternate installation of the rim liner on the rim.

FIG. 9 is a flow diagram detailing the steps of a first exemplary spray-on application of the rim liner to a rim.

FIG. 10 is a flow diagram detailing the steps of a second exemplary spray-on application of the rim liner to a rim.

FIG. 11 is a flow diagram detailing the steps of an exemplary over-mold application of the rim liner to a rim.

### DESCRIPTION OF PREFERRED EMBODIMENT

Specific embodiments of the present invention will now be described with reference to the figures. The following detailed description is merely exemplary in nature and is not intended to limit the invention or the application and uses of the invention. A person skilled in the relevant art will recognize that other configurations and arrangements can be used without departing from the scope of the invention. Although the description of the embodiments hereof is in the context of automotive rims, the invention may also be used in rim applications for other types of wheeled vehicles and equipment, including split rim and run flat applications. Furthermore, there is no intention to be bound by any expressed or implied theory presented in the preceding technical field, background, brief summary or the following detailed description.

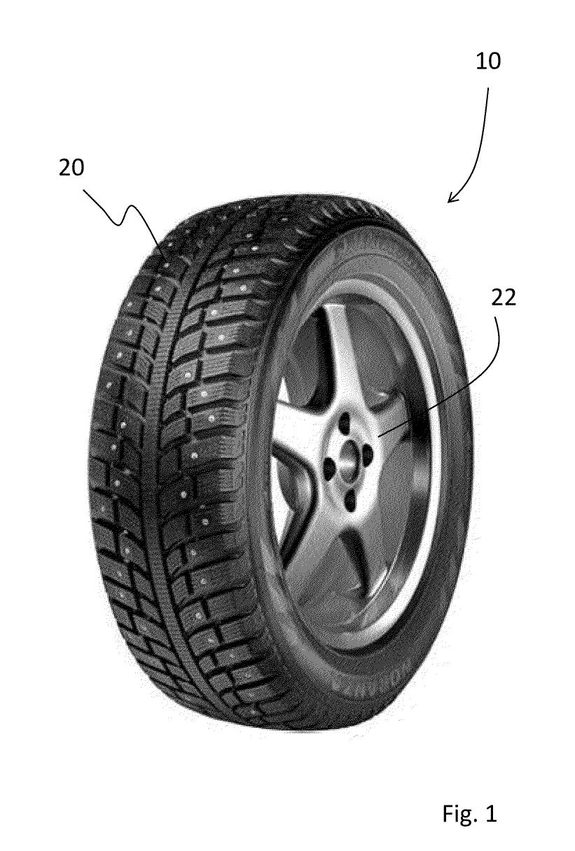

Presented in FIG. 1 is perspective view of a wheel 10, such as for an automobile, where the wheel generally includes a tire 20 and a rim 22. While exemplified with respect to a wheel of an automobile, the invention will work with the wheel of any type of vehicle including but not limited to cars, trucks, heavy trucks, buses, all-terrain vehicles, bicycles and aircraft.

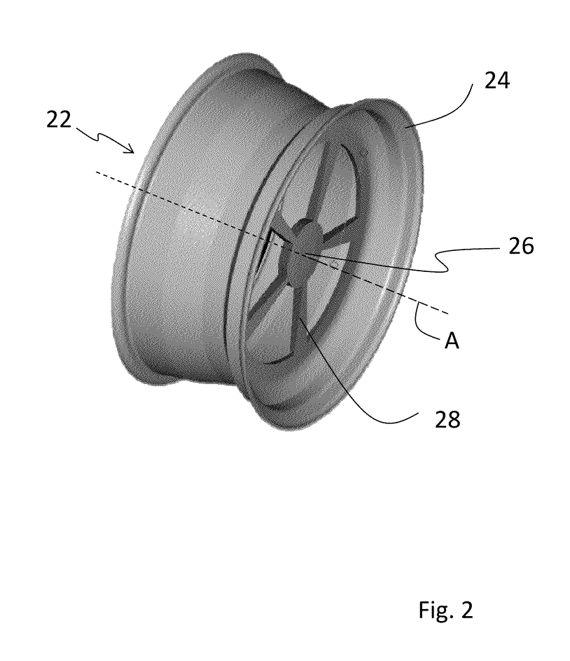

Turning now to FIG. 2, rim 22 is configured to support tire 20. Rim 22 is generally made of a metal such as an aluminum alloy, magnesium or steel. Rim 22 includes an outer ring-shaped member 24 connected to a central hub 26 through an intermediate connection member 28. As shown, outer ring-shaped member 24, central hub 26 and intermediate connection member 28 are unitary, that is rim 22 is of one-piece construction. As will be appreciated, other rim systems are possible where at least one of outer ring-shaped member 24, central hub 26 and intermediate connection member 28 are formed as a separate component, and incorporated into the overall rim assembly, for example as found with split rim or combinations of run-flat geometries. While intermediate connection member 28 is represented in a spoke-like configuration, that is with a series of 5 radially extending support vanes connecting hub 26 to outer ring-shaped member 24, intermediate connection member 28 may be provided in a range of styles as dictated by the design of rim 22, where functionally, intermediate connection member 28 serves to provide a secure connection between central hub 26 and outer ring-shaped member 24.

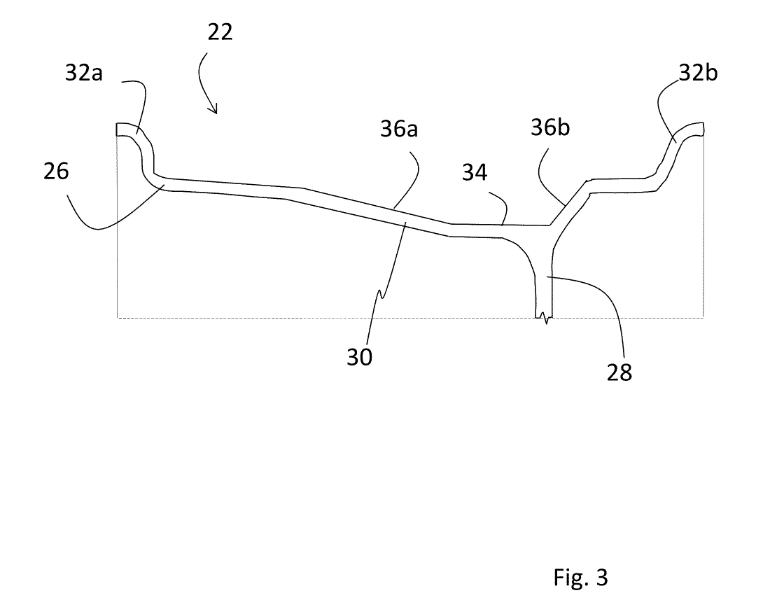

Referring now to FIG. 3, outer ring-shaped member 26 of rim 22 includes a base 30, and a pair of flange members 32a/b. Flange members 32a/b are generally disposed symmetrically with respect to base 30 extending from both ends of base 30 in the radially outward direction having regard to axis A of rim 22. Also formed into base 30 is a drop center 34 having angled surfaces 36a/b to facilitate the mounting of tire 20 during the installation process. Rim 22 is also configured to accommodate a valve stem (not shown) by providing a valve stem hole or similar feature (also not shown) to permit inflation of tire 20 mounted on rim 22.

Air leakage from the tire bead/rim interface can arise from a number of reasons. In particular, leakage can arise from physically damaged rims (e.g. dents, cracks, etc.) as well as from rims having corrosion or oxidation along the bead-set. Corrosion issues are of particular concern with alloy rims (e.g. aluminum alloy) where galvanic corrosion or chemical attack arising from environmental factors (e.g. asphalt, salt, etc) can be especially problematic around the tire bead seat and across the main body of the rim. Moisture introduced to the tire through the valve steam during inflation can also initiate oxidation on the main body of the rim causing slow propagation of air leak directly through the rim.

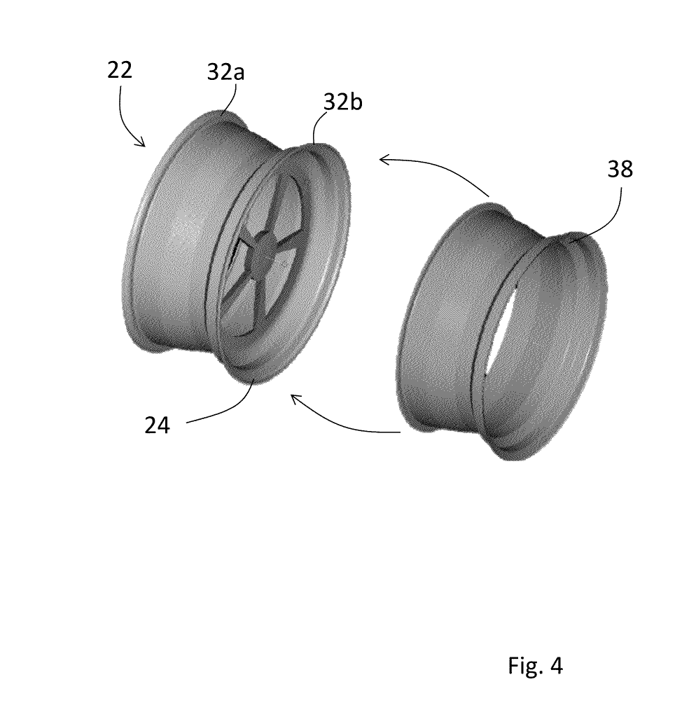

To reduce the possibility of air leakage from the tire bead/rim interface, and the main body of the rim in general, a supplemental rim liner, such as that shown in FIG. 4 may be utilized. Rim liner 38 is generally ring-shaped and designed to fit on outer ring-shaped member 24 of rim 22. As such, at the tire bead/rim interface, rim liner 38 provides an added barrier to reduce the potential impacts of oxidation and/or physical rim damage at the bead seal directly, or across the main body of the rim.

Rim liner 38 may be formed of any suitable elastomeric, polymeric or thermoplastic polyester elastomeric (TPE)-based material having the desired performance characteristics, for example low permeation. For installation purposes, it is useful for rim liner 38 to be made of a material capable of being stretched over one of flange members 32a/b, similar to standard tire installation procedure. Suitable materials include, but are not limited to thermoplastic polyester elastomers (e.g. Hytrel™) particularly those having low permeation characteristics, but as will be appreciated, other materials having the required performance characteristics may also be implemented.

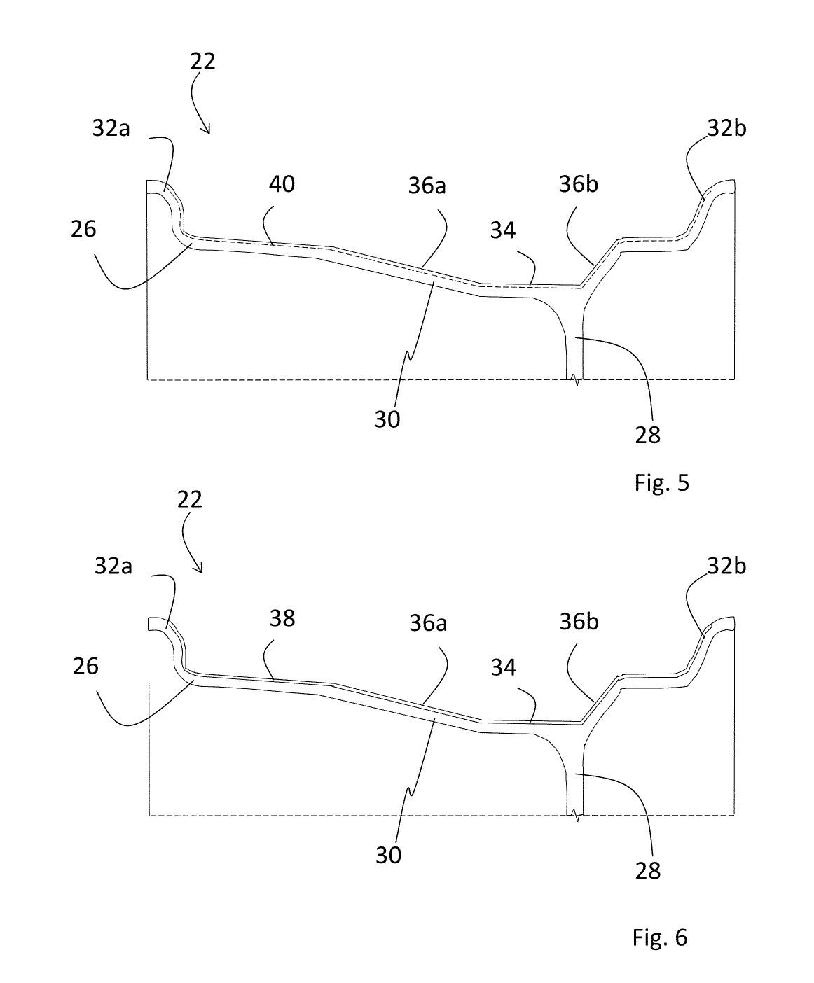

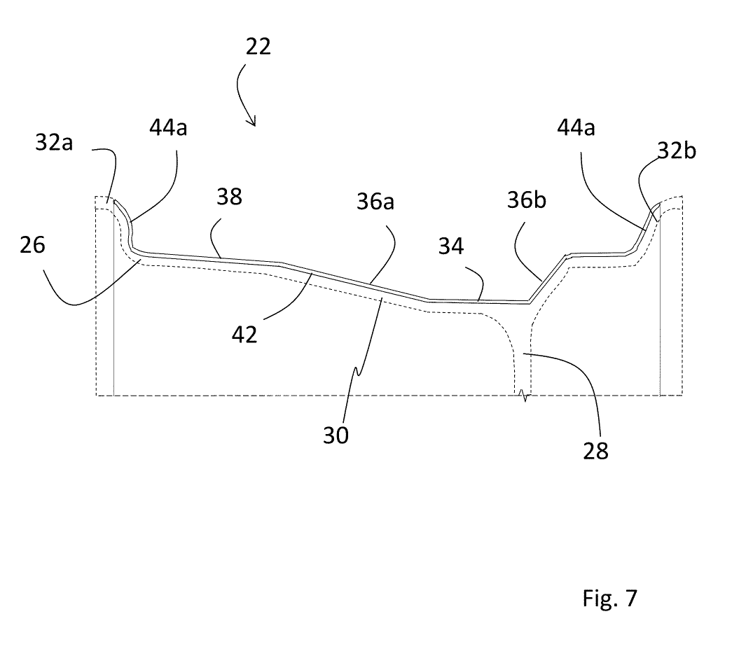

For motor vehicles, there are standards, for example the Federal Motor Vehicle Safety Standard which defines requirements for a variety of factors, such as tire dimensions, high speed performance, endurance, low inflation pressure performance, tire strength, and bead unseating resistance. Tire/rim sizing can have a major influence on these factors; consequently, tire/rim sizing is very specific in order to achieve a proper seal therebetween. Tolerances are such that minor variances in rim and/or tire diameter can impact whether or not a proper and sustainable seal is established. As such, and as shown in FIGS. 5 and 6, rim liner 38 is configured to seat within a recess 40 (shown in dot) provided on flange members 32a/b and base 30 of rim 22.

Accordingly, referring now to FIG. 7, rim liner 38 is generally a ring-shaped body formed to match the contours of the outer surface of outer ring-shaped member 26 of rim 22. As shown, rim liner 38 includes a liner base 42 having a profile to match/cooperate with rim base 30, including drop center 34. Rim liner 38 also provides a pair of flange extensions 44a/b that match/cooperate with flange members 32a/b of rim 22. As such, on installation of rim liner 38 on rim 22, the final diameter of the resulting rim assembly conforms to industry standard sizing for rims and tires.

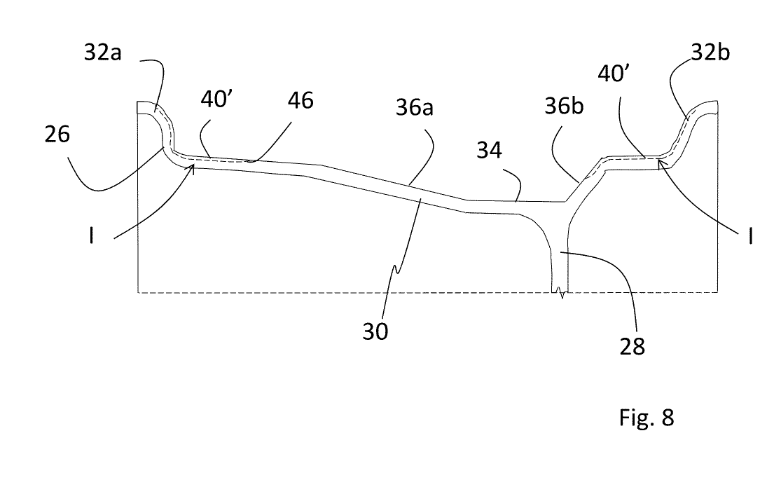

While recess 40 is detailed above and in the figures as being provided substantially across the entire outer surface of the outer ring-shaped member of rim 26, that is on both flange members 32a/b and base 30, in some embodiments, the recess to accommodate rim liner 38 is limited to the regions defining the original tire bead/rim interface I. For example, as shown in FIG. 8, rim 22 is configured to provide a pair recesses 40′ that receive rim liner 38 (not shown for clarity). The central region in-between is not recessed as conformation to a specified industry standard diameter is less critical along base 30. To reduce localized stresses in rim liner 38, the transition 46 between the machined and non-machined areas maybe sloped or tapered, or otherwise provided with a gradual transition.

Rim liner 38 is generally provided with a thickness in the range of 0.5 mm to 1.5 mm, although a thickness above or below this range may be used. As will be appreciated, recess 40 (40′), designed to accommodate rim liner 38 is similarly dimensioned so as to achieve the aforementioned industry standard sizing. As such, recess 40 (40′) will also generally be provided in the range of 0.5 to 1.5 mm deep. For example, in one particular embodiment, where rim liner 38 is provided with a thickness of 0.8 mm, recess 40 (40′) is similarly provided with a depth of 0.8 mm. It will be appreciated, however that in some embodiments, rim liner 38 may be provided with a thickness that is either less than, or greater than the depth defining recess 40 (40′).

Recess 40 (40′) provided on rim 22 may be formed through a post-manufacturing machining process. For example, in the case of used rims having corrosion at the tire bead/rim interface, the corrosion may be machined off to provide recess 40 (40′) having the required dimensions to seat rim liner 38 in position. A post-manufacturing machining process may also be used on newly manufactured rims so as to achieve recess 40 (40′). In general, the post-manufacturing machining process is contemplated as an aftermarket service available for upgrade and/or repair situations.

In new installations, for example with an original equipment manufacturer, while a post-manufacturing machining process may be used, it may be advantageous and cost effective to incorporate recess 40 (40′) into the initial rim design. As such, newly manufactured rims are provided with recess 40 (40′), subsequent to which they are fitted with rim liner 38 to achieve the final end product having the desire industry standard sizing.

While the rim liner may be separately formed, for example through an injection molding process, alternate methods to set the rim liner in position on the rim may be implemented. For example, in one embodiment, the rim liner may be applied through a spray-on process.

Spray-on application may be achieved through the use of a variety of suitable spray methodologies, including, but not limited to thermal spraying. As known in the art, and therefore not detailed herein, thermal spraying implements a specialized spray gun or nozzle in which melted or heated material (e.g. polymer) is sprayed onto a surface. Suitable materials include any of those detailed above that are compatible with a spray-on application. For example, the materials may include elastomeric, polymeric or thermoplastic polyester elastomeric (TPE)-based material having the desired performance characteristics, such as low permeability.

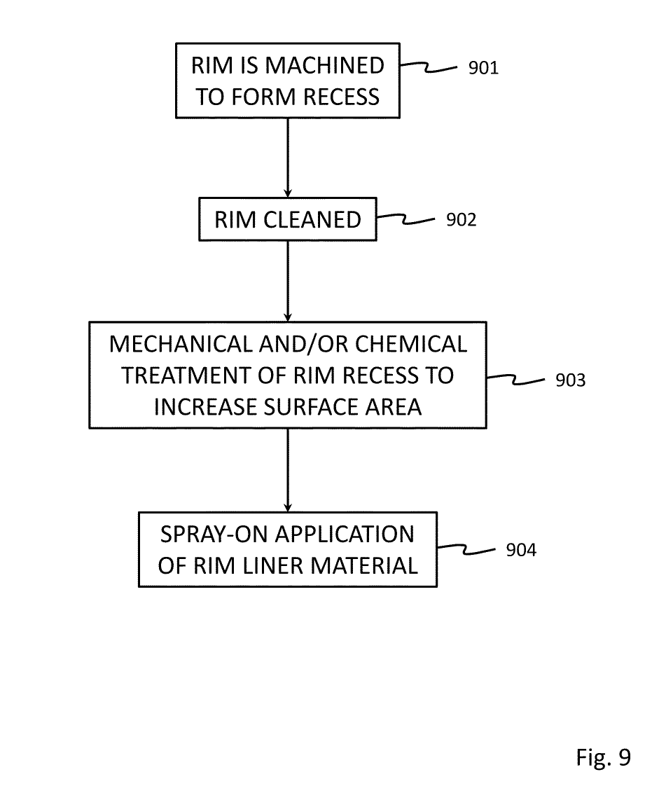

Referring now to FIG. 9, shown is a flow diagram detailing the steps of an exemplary spray-on application of rim liner. At step 901, a rim to which the rim liner is to be applied is machined to form the desired recess into which the rim liner is to be applied. At step 902, the rim is cleaned of any manufacturing oils or lubricants remaining from the manufacturing and/or preparation of the recess. At step 903, the rim is chemically and/or mechanically treated. This treatment increases the surface area of the rim in the region of the recess, so as to improve adhesion of the rim liner material to the rim. For example, the rim may be subject to a mechanical treatment methodology such as shot blasting in the region of the recess to increase surface area. At step 904, the rim liner material is applied to the rim, for example through a thermal spray methodology, to a predetermined thickness. As will be appreciated, the recess depth, and the exact thickness of the spray on rim liner is selected so as to achieve industry standard requirements (e.g. tire/rim seat/bead unseat procedures) and industry standard sizing.

In some embodiments, step 903 may be optional, that is it may be determined that with certain materials, a chemical or mechanical treatment to increase surface area may not be necessary. In other embodiments, instead of step 903 the spray-on material may incorporate a chemical additive that enhances the adhesion qualities with the rim.

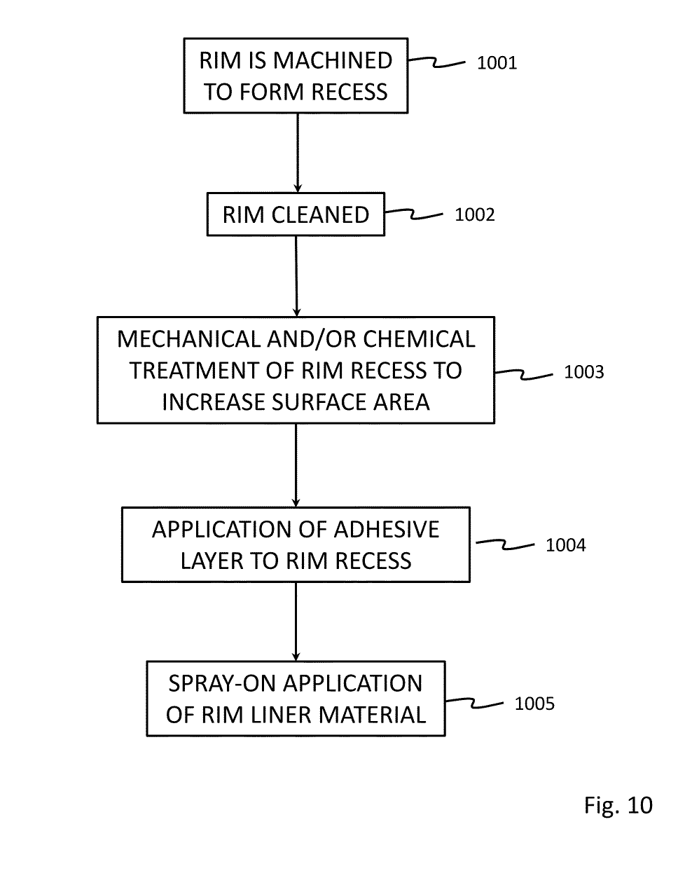

In other embodiments, an additional step of applying an adhesive layer may precede the application of the spray-on rim liner material. For example, shown in FIG. 10 is a flow diagram detailing the steps of an exemplary spray-on application of the rim liner, including the application of an adhesive layer. At step 1001, a rim to which the rim liner is to be applied is machined to form the desired recess into which the rim liner is to be applied. At step 1002, the rim is cleaned of any manufacturing oils or lubricants remaining from the manufacturing and/or preparation of the recess. At step 1003, the rim is chemically and/or mechanically treated. This treatment increases the surface area of the rim in the region of the recess, so as to improve adhesion of the rim liner material to the rim. For example, the rim may be subject to a mechanical treatment methodology such as shot blasting in the region of the recess to increase surface area. At step 1004, an additional adhesive may be applied to the recess to further improve the bond characteristics between the rim and the spray-on rim liner. As will be appreciated, suitable adhesives include those that are compatible with both the metal substrate of the rim, and the spray-on rim liner material to be applied thereto, thus enabling a secure bond therebetween. While the additional adhesive may be a single component system, the adhesive in some cases may in fact be a multi-layer arrangement. For example, a multi-layer adhesive may include a first primer layer to be applied directly to the metal rim substrate, and a second adhesive layer that bonds to the primer layer. Accordingly, the primer layer is generally selected on the basis of compatibility with the rim metal substrate, while the adhesive layer is selected on the basis of compatibility with both the primer layer, and the rim liner spray-on material. A range of adhesives (operable with/without primer layers) are known in the industry to enhance adhesion between plastics and metals, based on chemical and/or mechanical bonding. Where necessary, it will be appreciated that the rim may be subject to additional processing steps, for example heat curing. At step 1005, the rim liner material is applied to the rim, in particular on the adhesive layer, for example through a thermal spray methodology, to a predetermined thickness. As will be appreciated, the recess depth, and the exact thickness of the spray on rim liner is selected so as to achieve industry standard requirements (e.g. tire/rim seat/bead unseat procedures) and industry standard sizing.

As previously indicated, in some embodiments, step 1003 may be optional. Where an adhesive is implemented, it may be determined that chemical or mechanical treatment to increase surface area may not be necessary. In other embodiments, instead of step 1003 the spray-on material may incorporate a chemical additive that enhances the adhesion qualities with the rim.

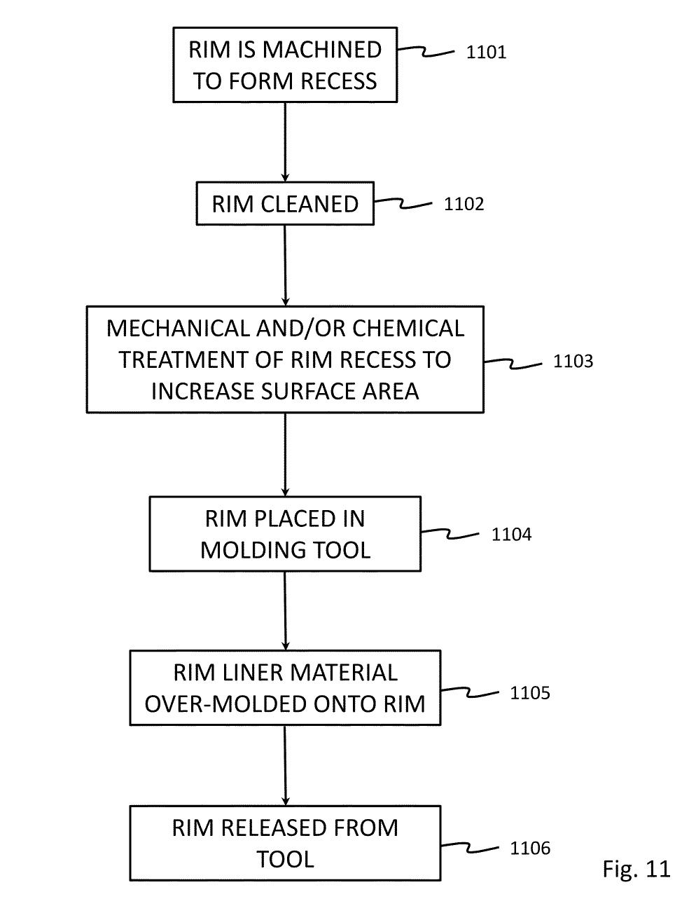

In yet a further alternate embodiment, the rim liner may be applied to the rim by way of an over-molding process. Referring to FIG. 11, shown is a flow diagram detailing the steps of an exemplary over-molding process. As in previous embodiments, at step 1101, the rim is machined to form the desired recess into which the rim liner is to be applied. At step 1102, the rim is cleaned of any manufacturing oils or lubricants remaining from the manufacturing and/or preparation of the recess. At step 1103, the rim is chemically or mechanically treated. This treatment increases the surface area of the rim in the region of the recess, so as to improve adhesion of the rim liner material to the rim. For example, the rim may be subject to a mechanical treatment methodology such as shot blasting in the region of the recess to increase surface area. At step 1104, the machined rim is placed in a suitable mold tool, designed to provide a void corresponding to the dimensions of the desired rim liner to be located in the recessed area of the rim. As will be appreciated, the dimensions of the void, and thus the resulting thickness of the over-molded rim liner is selected so as to achieve industry standard requirements (e.g. tire/rim seat/bead unseat procedures) and industry standard sizing. At step 1105, the appropriate rim liner material is injection molded into the void, thus forming the over-molded rim liner on the rim. At step 1106, the rim with over-molded rim liner is released from the mold tool.

In some embodiments, step 1103 may be optional, that is it may be determined that with certain materials, a chemical or mechanical treatment to increase surface area may not be necessary.

It will be appreciated that the over-molding process detailed above is merely exemplary, as a variety of over-molding methodologies are known in the art, and may be suitably implemented to achieve placement of the rim liner on the rim. For example, alternate over-molding processes may include adaptations of one or more of the following: transfer molding, compression molding, and/or blow molding.

It will be appreciated that in addition to the spray-on and over-molding processes detailed above, still further alternatives may be suitably implemented to set the rim liner material in position on the rim. For example, further alternatives may include electrostatic coating deposition, as well as specialized spin-dipping processes.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1. A rim assembly for receiving a tire, comprising:
a rim having an outer ring-shaped member defining an outer surface; and
a rim liner having a ring-shaped body formed to generally match the contours of said outer surface of said rim,
wherein said rim liner is positioned within a recess formed in at least a portion of said outer surface of said rim so as to maintain an intended industry standard sizing for rims and tires.

2. The rim assembly according to claim 1, wherein said rim liner is manufactured of a low permeation material.

3. The rim assembly according to claim 2, wherein said low permeation material is a thermoplastic polyester elastomeric-based material.

4. The rim assembly according to claim 3, wherein said thermoplastic polyester elastomeric-based material is Hytrel™.

5. The rim assembly according to claim 1, wherein said recess is provided substantially across said outer ring-shaped member.

6. The rim assembly according to claim 1, wherein said recess is limited to the regions defining the tire bead/rim interface.

7. The rim assembly according to claim 1, wherein said recess is provided with a depth that matches the thickness of the rim liner being used.

8. The rim assembly according to claim 1, wherein said rim liner is provided with a thickness in the range of 0.5 mm to 1.5 mm, and wherein said recess is dimensioned with a depth in the range of 0.5 mm to 1.5 mm.

9. The rim assembly according to claim 1, wherein said rim liner is applied to said rim by way of spray application.

10. The rim assembly according to claim 1, wherein said rim liner is applied to said rim by way of over-molding.

11. A rim liner for placement between a tire and a rim of an automotive wheel assembly, the rim liner comprising:
a ring-shaped body formed to generally match the contours of an outer surface of said rim, said ring-shaped body being configured to seat within a recess provided in said rim, so as to maintain an intended industry standard sizing for rims and tires.

12. The rim liner according to claim 11, wherein said rim liner is manufactured of a low permeation material.

13. The rim liner according to claim 12, wherein said low permeation material is a thermoplastic polyester elastomeric-based material.

14. The rim liner according to claim 13, wherein said thermoplastic polyester elastomeric-based material is Hytrel™.

15. The rim liner according to claim 11, wherein said rim liner is provided with a thickness in the range of 0.5 mm to 1.5 mm.
